(19) United States
(12) Patent Application Publication
(10) Pub. No.: US 2022/0134871 A1
(43) Pub. Date: May 5, 2022

(54) TANK SHELL WITH MOUNTED COMPONENT ARRANGED LIQUID-TIGHT THEREON

(71) Applicant: Röchling Automotive SE & Co. KG, Mannheim (DE)

(72) Inventors: Dieter Kerschbaumer, Tramin (IT); Petru-Sorin Muj, Bolzano (IT); Ivan De Metri, Bolzano (IT)

(73) Assignee: Röchling Automotive SE & Co. KG

(21) Appl. No.: 17/511,834

(22) Filed: Oct. 27, 2021

(30) Foreign Application Priority Data
Nov. 3, 2020 (DE) 10 2020 128 975.8

(51) Int. Cl. B60K 15/03

(52) U.S. Cl. CPC B60K 15/03; B60K 2015/03493; B60K 2015/03032

(57) ABSTRACT

A tank shell as a component of a motorized vehicle tank, where the tank shell includes as wall components a barrier foil and injection-molding material injected thereon at least locally on at least one side, where the tank shell exhibits an aperture configured for the arrangement of a functional component configured with a space section located on an internal side of the tank shell, wherein in a rim region of the tank shell surrounding the aperture there is arranged a socket component which at least section-wise is formed from a material different from the materials of the wall components of the tank shell, where the socket component is connected positively and/or is firmly bonded with the rim region of the tank shell.

This Application claims priority in German Patent Application DE 10 2020 128 975.8 filed on Nov. 3, 2020, which is incorporated by reference herein. The present invention concerns a tank shell as a component of a motorized vehicle tank, where the tank shell comprises as wall components a barrier foil and injection-molding material injected thereon at least locally on at least one side, where the tank shell exhibits an aperture configured for the arrangement of a functional component configured with a space section located on an internal side of the tank shell.

### BACKGROUND OF THE INVENTION

Such a tank shell and a tank formed from it are known from US 2015/0102026 A1. The known tank shell comprises a barrier foil consisting of a central barrier layer made of EVOH, at which are arranged on both sides connective layers made from polyethylene in order to be able to connect polyethylene as a material of a structure-forming tank wall with the barrier layer.

US 2015/0102026 A1 describes appositely that tank walls formed solely from polyethylene are insufficiently permeation-resistant to hydrocarbons which evaporate from fuels stored in the tank. Consequently, the hydrocarbons can migrate through tank walls made only from polyethylene to the exterior of the tank. Therefore, the tank walls are additionally secured with the barrier foil against permeation of hydrocarbons through the tank walls.

A tank wall, however, has to be locally breached because certain functional components from outside the tank need access to the tank's volume. Such possible functional components are, for example, a feed pump for conveying the tank's content to a destination located outside the tank where at least the suction line of the feed pump has to terminate inside the tank, or a venting line, or a level sensor, and suchlike. At a breach of the tank wall, however, there can arise an elevated permeation risk, since the integrity of the barrier foil has to be impaired also for producing the breach.

### SUMMARY OF THE INVENTION

It is, therefore, the task of the present invention to further develop the tank shell referred to in the beginning in such a way that the aforementioned functional component can be arranged at the tank shell with the smallest possible permeation risk in the region of the aperture configured for the functional component.

The present invention solves this task in a tank shell referred to in the beginning such that in a rim region of the tank shell surrounding the aperture a socket component is arranged which at least section-wise is formed from a material differing from the materials of the wall components of the tank shell, where the socket component is positively connected and/or firmly bonded with the rim region of the tank shell.

Through the arrangement of the socket component as a mounted component on which the functional component can be mounted, a defined structure can be provided for the accommodation of the functional component at the aperture, which structure is optimally matched to the functional component that is to be accommodated and thus considerably facilitates its arrangement at the tank. Through the use of a material differing from the materials of the wall components of the tank shell, i.e. barrier foil and at least locally injected synthetic material, a material optimally suited for the accommodation of the functional component can be chosen regardless of the materials used for forming the wall components of the tank shell.

The connection of the socket component with the rim region of the tank shell through positive connection and/or firm bonding provides an especially secure connection with high joint strength, which advantageously allows the securing of the rim region against undesirable permeation of substances stored inside a tank formed with the tank shell to the exterior of the tank.

The tank shell is a part-shell of a motorized vehicle tank, which is configured for connecting with at least one further tank shell. The tank shell can exhibit a joint structure, for instance a joint flange, which is configured for forming a joint with the further tank shell, preferably for producing a firmly bonded joint, such as for instance a welded joint and/or a glued joint. The tank shell can be, for example, a tank upper shell exhibiting a tank top and part of a tank side wall, or a tank lower shell exhibiting a tank bottom and part of a tank side wall. The tank shell is normally configured as curved in one direction starting from the joint structure configured at it for forming a joint with the further tank shell.

The tank shell is preferably formed by the barrier foil, which is formed in a basic form of the tank shell, for example through thermoforming in an appropriately designed molding tool. Onto the formed barrier foil, which is dimensionally stable under the effect of its own weight and maintains its shape that is forced onto it by forming, there is then injected at least locally at least on one side injection-molding material. In doing so, injection-molding material can be injected onto at least 80%, preferably at least 90%, of the areal extension of an internal side of the tank shell facing towards the inner volume of a tank formed with the tank shell as an inner tank wall structure, for instance in order to form on the inside mounting structures for the mounting of add-on parts or anti-surge structures or the like. Preferably, the inner side of the tank shell can be covered all over with injected injection-molding material.

Additionally or alternatively, the external side of the tank shell facing towards the external environment of the tank formed with the tank shell can be covered on at least 80%, preferably at least 90%, of its areal extension with injected injection-molding material as an outer tank wall structure. Advantageously, the tank shell can exhibit at least one sealing region, which is configured for the installation of a sealing component and which is free from injected injection-molding material. Thereby, a sealing component arranged at the tank shell can abut the barrier foil directly and thus provide better permeation protection compared with a sealing component abutting an injected synthetic material. The sealing component thus arranged as abutting the barrier foil directly can, for example, seal against the socket component and/or against a functional component accommodated by the socket component. The sealing region preferably surrounds the aforementioned aperture.

The socket component is preferably an annular component surrounding the aperture, which preferably exhibits metal as a material differing from the materials of the wall components of the tank shell, in particular stainless steel because of its chemical stability.

It should not be precluded that the socket component at least locally is coated with a synthetic material or exhibits at least one synthetic section, in order to facilitate firm bonding with an injection-molded section of the tank shell. In this case, a local synthetic coating of the socket component is preferably made from a synthetic which is compatible, preferably identical, with the injection-molding synthetic of the tank shell.

Instead of only local synthetic coating, it is also possible for the whole socket component to be covered with a synthetic skin.

As will be shown hereinunder, however, for reasons of cost the socket component is preferably a metal component which is made only of metal, in particular of stainless steel because of its chemical stability.

A virtual aperture axis conceived as centrally passing through the aperture in the tank shell is the basis of a coordinate system for describing the present invention. Unless stated otherwise in the present application, an axial direction is a direction along the aperture axis, a radial direction a direction orthogonal to the aperture axis, and a peripheral direction a direction around the aperture axis.

For increased dimensional stability of the rim region on the one hand and for the possibility of improved sealing of the socket component against the tank shell on the other, in particular against the rim region of the tank shell, it can be provided that the rim region of the tank shell exhibits a ramp encircling the aperture, which relative to the virtual aperture axis proceeds both along the aperture axis and transversely to the aperture axis. The ramp proceeds, in particular when approaching radially, from a starting point situated further away from the aperture axis to an end point situated nearer to the aperture axis, where the ramp is located radially between the starting and end points, both in the axial and in the radial direction.

The ramp, in whose extension region a wall section of the tank shell including the barrier foil proceeds both along the aperture axis and transversely to the aperture axis, forms due to this course a stiffening of the rim region, such that a given external force acting on the ramp results in a smaller deformation of the rim region than had the ramp not been formed. Furthermore, due to the aforementioned course the surface of the rim region in the extension region of the ramp can be enlarged, which facilitates the arrangement and/or forming of a seal.

A section of the socket component overlaps the ramp radially when viewed axially along the aperture axis. Due to this overlap, the space between the ramp and the socket component can be used advantageously for sealing a gap which normally is present between the tank shell and the socket component.

The encircling ramp can project axially inward starting from the wall region of the tank shell surrounding it towards the tank's internal space and/or towards the space region situated on the internal side of the tank shell, respectively or it can project axially outward towards the external region of the tank and/or of the tank shell, respectively. In order to facilitate the connection of the rim region with the socket component, at least one section of the ramp is over-injected with injection-molding material.

Since the functional component is normally mounted from outside onto the tank shell or onto the tank formed with the tank shell, preferably the socket component is arranged on the external side of the tank shell. Here it can be advantageous if the ramp projects towards the tank's internal space, such that the socket component can be inserted on the external side of the tank shell in a recess or depression around the aperture formed in part or wholly by the ramp.

Preferably, an injection-molded layer is injected onto the internal side of the tank shell at least locally, preferably completely, in order to protect the barrier foil from direct contact with fluid which is accommodated in the tank formed with the involvement of the tank shell.

The ramp can in principle exhibit an arbitrary tapering shape, for example a conical shape, which makes possible simultaneous axial and radial extension. Likewise, it should not be precluded that the ramp has a curved course when viewing a longitudinal section along a sectional plane containing the aperture axis, for example a concave course or a convex course when viewing the tank shell from outside. In order to form the most defined mounting or orientation surfaces possible in the rim region, the ramp is preferably configured as a stepped ramp with a first, predominantly axially proceeding wall section and with a second, predominantly radially proceeding bottom section different from the first one. The predominantly axially proceeding wall section can be configured to proceed only axially. Likewise, the predominantly radially proceeding bottom section can be configured to proceed only radially. Proceeding “predominantly” in one direction shall mean here that the relevant section can be configured to proceed not only in the given direction, but also in a direction orthogonal to it, but the component proceeding along the given direction is greater than the component proceeding along a direction orthogonal to the given direction.

In the region of the ramp, between the tank shell and the socket component there can be accommodated a sealing component which seals a gap between the tank shell and the socket component in the radial direction. The sealing component can be a sealing component configured separately both from the socket component and also from the tank shell. The sealing component can for example be an O-ring encircling the aperture. Since often the socket component is placed axially from outside on the tank shell, the sealing component is preferably arranged at the bottom section and abuts onto it, such that the sealing component can be compressed axially between the socket component and the bottom section axial in order to increase its sealing effect.

The sealing component preferably abuts the barrier foil, which to this end is preferably exposed towards the sealing component in the sealing region of the seating of the sealing component. Thereby the closest possible contact of the permeation-inhibiting sealing component with the likewise permeation-inhibiting barrier foil is guaranteed. Additionally or alternatively, the sealing component preferably abuts the socket component or the functional component. At least the region of the socket component in which the sealing component abuts, is preferably made of metal such that this region of the socket component forms a good permeation barrier against the migration of hydrocarbons from the tank.

Additionally or alternatively, in the region of the ramp there can be injected injection-molding material, which at least firmly bonds the socket component with the tank shell.

Then at least in the region of the injected injection-molding material, the socket component can be firmly bonded with the tank shell. In order to increase the joint strength, the socket component can exhibit an anchor section which proceeds into the injected injection-molding material, and which is engaged behind by the injection-molding material in the lifting direction of the socket component away from the tank shell. The anchor section can for example be a perforated material section, in particular a metal plate section, of the socket component. Instead of a hole penetrated by injection-molding material or additionally hereto, the anchor section can exhibit material side-pieces projecting into the injection-molding material, which preferably enclose an angle, in particular an angle between 40° and 130°, with the lifting direction, and which preferably are surrounded on all sides by injection-molding material. Consequently, in addition to firm bonding the socket component can exhibit by means of the anchor section a positive connection with the tank shell.

In principle it can suffice to configure the ramp in the rim region of the tank shell around the aperture, where the ramp with its radially inner rim can frame the aperture in the tank shell and form an aperture rim directly. An improved permeation barrier in the region of the aperture of the tank shell can, however, be obtained by the ramp being part of a concave groove formation of the tank shell encircling the aperture. When viewing the rim region in the aforementioned longitudinal section on the basis of a sectional plane containing the aperture axis, the groove formation exhibits a roughly U-shaped course. In principle, the groove formation can be, when looking outward from the socket component and/or from outside respectively, curved convexly towards the aperture. Preferably, however, the groove formation is curved concavely when looking outward from the socket component, such that the socket component can be inserted in the groove at least in part and pre-positioned in it from the external side of the tank shell.

The groove formation can exhibit a radially interior inner wall section as a radially inner boundary, which proceeds predominantly in the axial direction. The ramp is then situated radially outside the inner wall section and surrounds the latter. Preferably, the barrier foil also extends along the inner wall section, in order to form a kind of collar, as it were, at the rim region surrounding the aperture, along which permeation of tank content through the inner wall section and its barrier foil is prevented or inhibited. In order to achieve the best possible permeation barrier, the barrier foil extends up to the radial and/or axial end of the inner wall section.

Because of the permeation barrier produced by the inner wall section, it is preferable if the inner wall section projects axially towards the tank's external side above the ramp and/or an outer wall of the tank shell surrounding the aperture.

Preferably, the inner wall section forms an immediate edging of the aperture of the tank shell. Due to the option of injecting injection-molding material on both sides of the barrier foil, the inner wall section which preferably projects outwards towards the tank's external side, can be configured in addition so as to project towards the space region on the internal side of the tank shell. As a result, an axially especially long collar and/or neck respectively of the aperture in the tank shell would be obtained.

Although it is stated above that the inner wall section can exhibit the barrier foil, it should not be precluded that the inner wall section is free from the barrier foil wholly or in part. This depends essentially on the shape of the socket component and/or on the type of its attachment to the tank shell.

For example, the inner wall section can be configured as discontinuous in the circumferential direction around the aperture axis. Wall projections of the socket component can be arranged in discontinuities of the inner wall section. The inner wall section can then project in a crenellated manner axially from the the tank shell, in particular from the ramp of the tank shell. Likewise, the wall projections of the socket component can protrude in a crenellated manner axially from a carrier section of the socket component. The wall projections and inner wall crenellations of the inner wall section which is configured in a crenellated manner can be arranged to interlace in one another, such that in a circumferential direction a crenellation of the inner wall section and a wall projection of the socket component follow each other alternately. The carrier section from which the wall projections of the socket component protrude, can at the same time be the section of the socket component in which the aforementioned sealing component fits. In this case, in order to achieve cost advantages it can suffice if the inner wall section which is configured in a crenellated manner is free from the barrier foil. The sealing towards the outside can then take place between the barrier foil, the sealing component supported by it, and the carrier section of the socket component by which the sealing component is likewise supported.

Additionally or alternatively to the firm bonding of the socket component with the tank shell described above, the socket component can be connected positively with the rim region of the tank shell, for example through crimping. To this end, it can be conceived to deform the aforementioned free longitudinal ends of the wall projections of the socket component plastically, in order to engage behind a section of the tank shell, for example a section of the ramp, in particular its bottom section. The crimping can comprise beading, squeezing, overtwisting, or folding.

Alternatively or additionally to crimping, the socket component can be connected to the rim region of the tank shell by riveting. To this end, riveting projections can be injected onto the internal side and/or the external side, preferably onto the external side, of the tank shell, which project away from the tank shell. The riveting projections are preferably configured integrally with an injection-molded tank wall structure on the external side of the tank shell. In this way riveting can be achieved by means of a synthetic rivet, without therefor having to prejudice the integrity of the barrier foil. Following arrangement of the socket component, the riveting projections penetrate through apertures of the socket component. Since the projections are formed out of a thermoplastic synthetic material, they can be reshaped into rivet heads engaging behind the socket component. The river head is then broader than the clear width of the aperture penetrated by the riveting projection and/or the later rivet shank respectively, such that the socket component can no longer be lifted off the tank shell non-destructively.

In addition to the tank shell described above, the present invention also concerns a motorized vehicle tank with at least one tank shell, as it is described above and further developed. The tank comprises at least two tank shells, which are connected with one another through jointing, such as welding or gluing. Preferably, all tank shells of the tank are configured in accordance with the description given above for one tank shell. Preferably, the tank comprises only two tank shells, for example an upper shell exhibiting a tank top and a lower shell exhibiting a tank bottom.

The present invention further concerns a motorized vehicle with a motorized vehicle tank with a tank shell, configured as described above. The motorized vehicle tank is preferably a fuel tank. Since hydrocarbons evaporating from gasoline or premium fuels can migrate especially easily through polyolefin tank wall structures, the motorized vehicle is preferably a motorized vehicle fitted with a gasoline engine.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 A schematic perspective view of a motorized vehicle tank with an aperture in the upper tank shell and with a socket component, which in a rim region of the tank shell surrounding the aperture is connected with the tank shell only by positive jointing,

FIG. 2 An enlarged schematic perspective view of the tank shell region exhibiting the aperture with the rim region of the tank shell surrounding the aperture without the socket component,

FIG. 3 A schematic perspective view of just the socket component of FIG. 1 in its shape after mounting on the tank shell,

FIG. 4 A schematic longitudinal section view through the rim region of the tank shell of FIG. 1 along a sectional plane containing the aperture axis,

FIG. 5 A schematic perspective view of a second invention embodiment of a tank shell of the present application,

FIG. 6 A schematic perspective view of the second embodiment of a socket component for connecting with the tank shell of FIG. 5,

FIG. 7 A schematic longitudinal section view through the rim region of the second invention embodiment of the tank shell with socket component connected with it along a sectional plane containing the aperture axis, and

FIG. 8 A schematic longitudinal section view through the rim region of a third invention embodiment of a tank shell with a functional component accommodated at the socket component, once again along a sectional plane containing the aperture axis.

### DESCRIPTION OF PREFERRED EMBODIMENTS

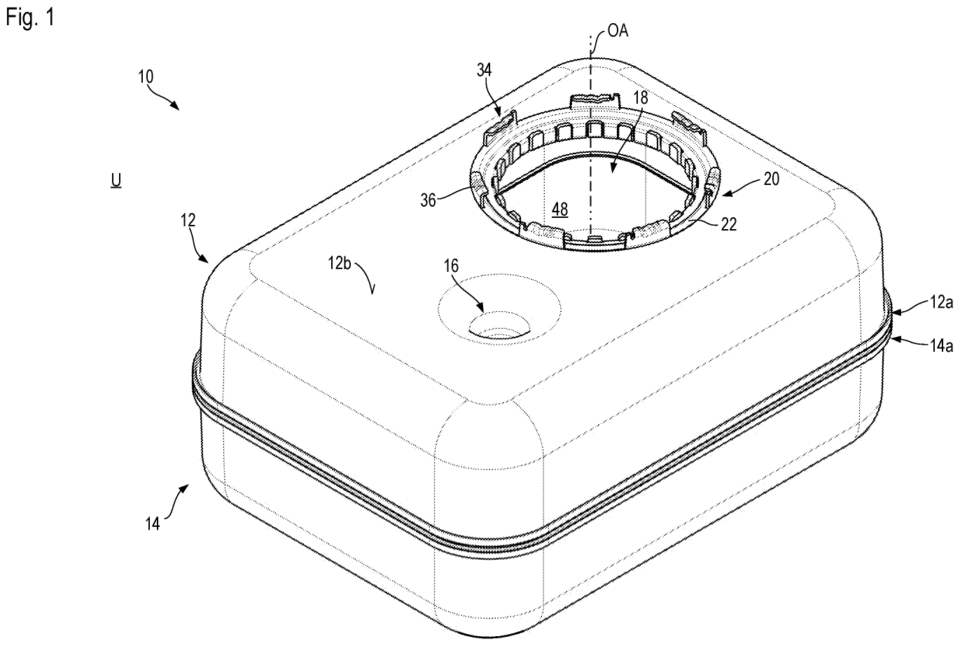

Referring now to the drawings wherein the showings are for the purpose of illustrating preferred and alternative embodiments of the invention only and not for the purpose of limiting the same, in FIG. 1, a schematically depicted tank for gasoline or premium fuel is denoted generally by 10. The tank 10 comprises a first invention embodiment of an upper tank shell 12 and a lower tank shell 14, which are jointed with each other approximately at the middle of the height of tank 10 along the respective encircling joint flanges 12a or 14a. The jointing of the tank shells 12 and 14 at their respective flanges 12a or 14a can take place through various types of welding methods, for example by means of mirror welding, infrared welding, ultrasound welding, laser welding, and the like.

On the tank's external side 12b of the upper tank shell 12 there is discernible a depression 16, in which a tie rod extends inside the tank 10 up to the bottom of the tank 10 in order to prevent in a manner which is known per se the tank 10 deforming when excess pressure forms inside the tank 10 against the atmospheric pressure of the external environment U. Such excess pressure can form, for example, in hybrid vehicles when they are propelled only electrically for a prolonged period and no fuel is extracted from inside the tank 10. The aforementioned pressure difference can arise through evaporation of fuel inside the tank 10.

The upper tank shell 12 exhibits on its upper side an aperture 18 which in the depicted example is circular and which penetrates completely through the tank shell 12. A virtual aperture axis conceived as penetrating centrally through the aperture 18 is denoted by OA. In the rim region 20 of the tank shell 12 surrounding the aperture 18 there is arranged an annular socket component 22, which in the depicted first embodiment is connected with the tank shell 12 only positively.

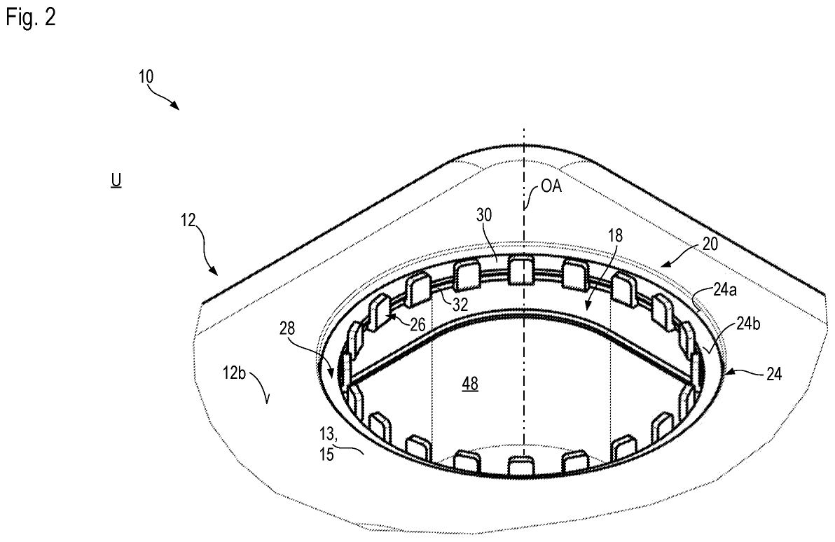

For the sake of improved clarity, the aperture 18 and the rim region 20 surrounding it of the first embodiment will first be described by reference to FIG. 2.

The area of the tank shell 12 surrounding the aperture 18 is formed on the external side 12b by outer injection-molding material 13.

The rim region 20 exhibits a stepped ramp 24 encircling the aperture 18, which is bounded radially inward towards the aperture axis OA by a crenellated inner wall section 26. The ramp 24 and the inner wall section 26 form a groove formation 28, which surrounds the aperture 18 and is curved concavely in the radial direction towards the aperture axis OA when viewed from outside.

The stepped ramp 24 exhibits a wall section 24a proceeding predominantly along the aperture axis OA and a bottom section 24b proceeding predominantly transversely and/or preferably radially to the aperture axis OA.

In the bottom section 24b, preferably in the entire bottom section 24b and further preferably only in the latter, there is situated a barrier foil 30 exposed towards the external environment U of the tank 10. Inwards towards the tank volume, the barrier foil 30 is covered in the bottom section 24b also by an inner injection-molding material 32.

The tank shell 12 is therefore formed radially outside the ramp 24, in the depicted embodiment example radially outside the bottom section 24b, by a sandwich structure, according to which a central barrier foil 30 is embedded between an injected outer injection-molding material 13 and an injected inner injection-molding material 32.

The barrier foil 30 is preferably a multilayer foil with a central layer made from EVOH or also from PVOH, to which a connective layer made from a polyolefin is affixed on both sides, in each case under interposition of an adhesion promoting layer, for instance made from LDPE or LLDPE. Preferably, the connective layer is made from HDPE, although this does not necessarily have to be the case. The outer injection-molding material 13 and the inner injection-molding material 32 are preferably identical and each comprise polyethylene, in order to achieve the best possible binding to the barrier foil 30 by means of the latter's outer HDPE connective layer.

Each tank shell 12 and 14 is created in the depicted example through forming, in particular thermoforming, of the barrier foil 30 in the shape of the tank shell 12 or 14 respectively and by injecting the outer injection-molding material 13 and of the inner injection-molding material 32 onto the external side or onto the internal side respectively of the formed barrier foil 30.

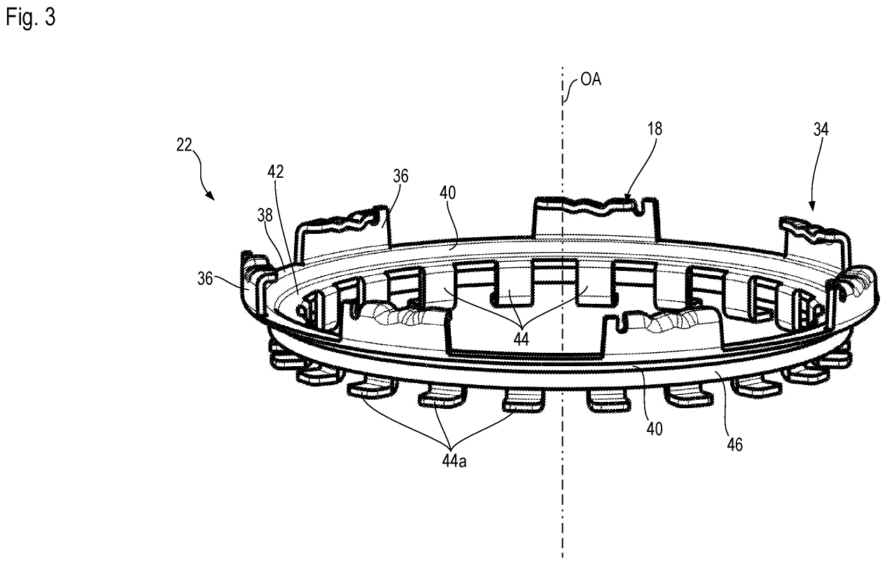

FIG. 3 depicts in a schematic perspective view the socket component 22 of the first embodiment. It comprises a coupling region 34 lying radially completely outside in the depicted embodiment example, with gripping formations 36 projecting axially towards the external side of the tank shell 12. The gripping formations 36 serve for mechanical positive connection with a functional component not shown in FIG. 3, for example an extracting module for extracting fuel from the tank 10.

Since the socket component 22 is arranged concentrically to the ramp 24 and to the rim region 20 of the tank shell 16, the aperture axis OA can also serve for describing the socket component 22.

In order to achieve especially high dimensional stability and bending stiffness about an arbitrary bending axis orthogonal to the aperture axis OA, the socket component 22 is preferably configured section-wise offset and comprises a radially outer rim 38 extending predominantly transversely to the aperture axis, from which rim 38 a predominantly axially extending stepped section 40 projects towards the tank's volume. To this stepped section 40 there is attached a carrier section 42 which again extends radially inward transversely to the aperture axis OA, from which carrier section 42 a large number of wall projections 44 protrude predominantly axially towards the tank volume. On the side of the carrier section 42 facing towards the tank shell 12 there fits a sealing component 46 in the shape of an O-ring.

The free longitudinal ends 44a of the wall projections 44 are deformed radially outward from the aperture axis OA away, in order to clamp the socket component 22 positively to the tank shell 12.

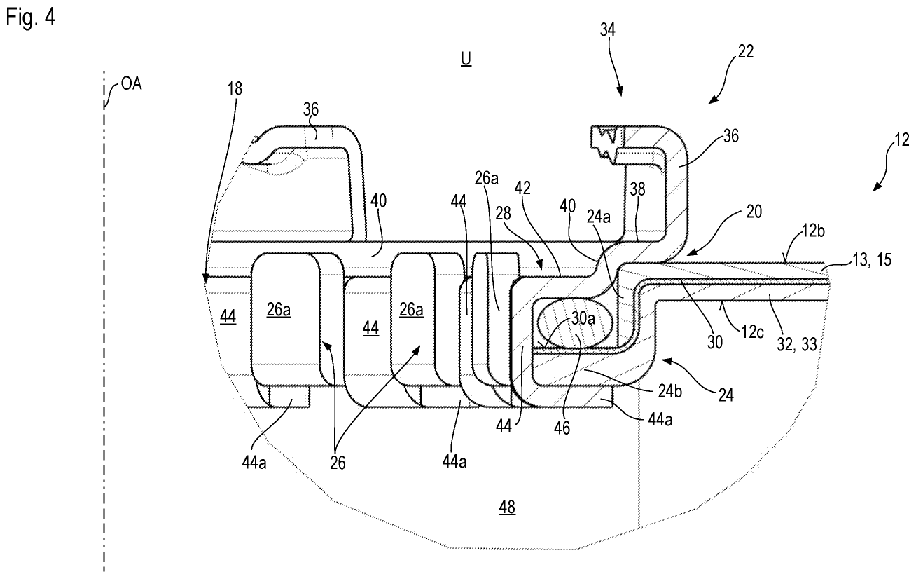

The connection of the socket component 22 to the tank shell 12 is more clearly discernible in the schematic longitudinal section view of FIG. 4.

FIG. 4 shows an enlarged cutout of the rim region 20 of the tank shell 12 in schematic longitudinal section, such that the internal side 12c of the tank shell 12 and the space region 48 situated on the internal side 12c are also visible, which at the tank 10 constitute part of the inner region and/or tank volume respectively of the tank 10.

FIG. 4 depicts how crenellations 26a of the discontinuously configured inner wall section 26 are arranged alternately with wall projections 44 in the circumferential direction. The wall projections 44 are, therefore, configured interlaced with the crenellations 26a of the inner wall section 26.

The wall projections 44 embrace with their free longitudinal ends 44a the bottom section 24b of the ramp 24, such that the free longitudinal ends 44a extend radially away from the aperture axis OA and clamp the socket component 22 positively to the tank shell 12.

The barrier foil 30 is situated radially outside the rim section 20 and still in the region of the wall section 24a sandwich-like between the outer injection-molding material 13 and the inner injection-molding material 32. The outer injection-molding material 13 forms an outer tank wall structure 15 and the inner injection-molding material forms an inner tank wall structure 33. Their respective thicknesses are quantitatively greater than the thickness of the barrier foil 30.

In the bottom section 24b, the barrier foil 30 is exposed towards the external environment U of the tank shell 12 and/or towards the carrier section 42 of the socket component 22, respectively. On its exposed surface 30a, which forms a sealing region as aforementioned, there abuts the sealing component 46. On the side axially opposite to the free surface 30a of the barrier foil 30 in the bottom section 24b, the sealing component 46 abuts on the side of the carrier section 42 that faces axially towards the inner space region 48. The clear axial height between the carrier section 42 and the bottom section 24b is smaller than the axial dimension of the unstressed sealing component 46, such that the latter is prestressed in the axial direction when installed at the aforementioned regions and thus can deploy its sealing effect.

Because of the sealing effect between the barrier foil 30 and the purely metallic carrier section 42 provided by the sealing component 46, the crenellations 26a of the inner wall section 26 injected onto the radially inner end of the bottom region 24b can consist solely of injection-molding material, preferably of the inner injection-molding material 32. They do not have to exhibit a barrier foil 30, since in the present case there is no dependence on a sealing effect provided by the crenellations 26a.

The free surface 30a of the barrier foil 30 can be formed by the HDPE connective layer. It can also, however, be melted away or removed in some other way, such that the sealing component 46 can also abut directly on the central barrier layer, preferably made from EVOH, of the barrier foil 30.

With the radially outer rim 38, which preferably extends in the radial direction, the socket component 22 can abut on the external side 12b of the tank shell 12 such that the wall projections 44 with their free longitudinal ends 44a can be crimped against the material elasticity of the ramp 24 and thus can clamp the socket component 22 with stabilizing prestressing free from play to the tank shell 12. For further freedom from play, the stepped section 40 abuts preferably radially on a part-region of the wall section 24a of the ramp.

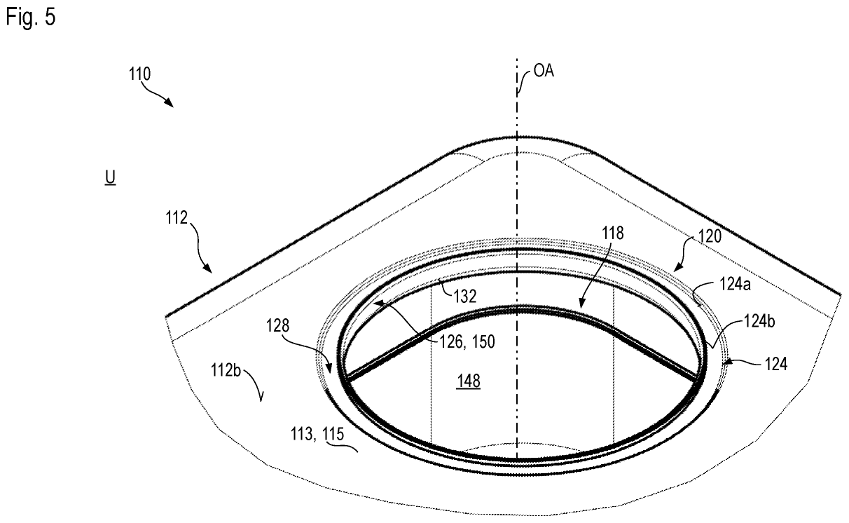

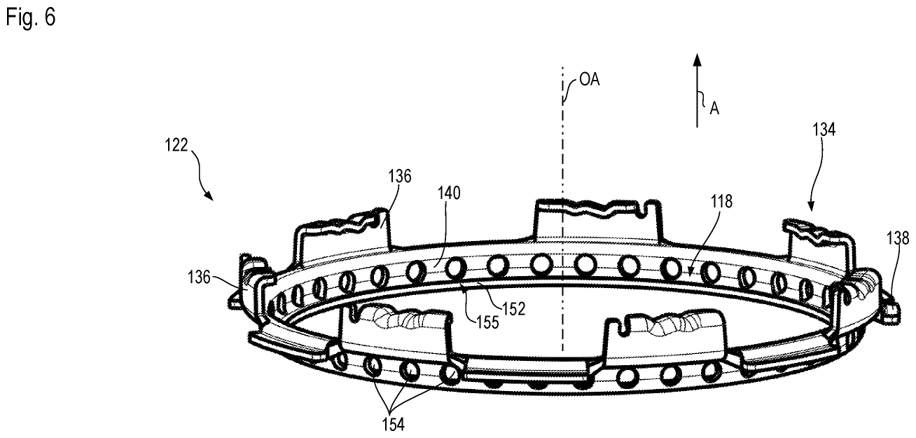

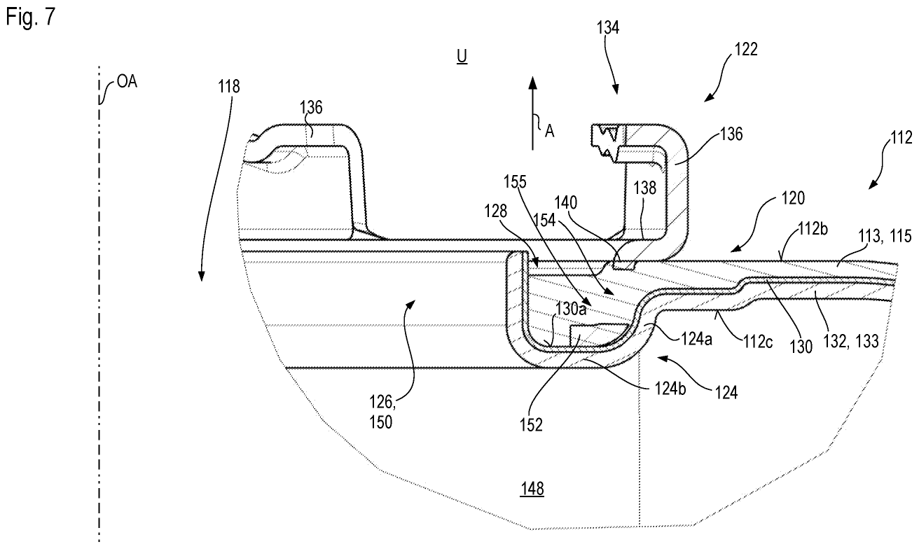

FIG. 5 depicts a second embodiment of the tank shell 112 in accordance with the perspective of FIG. 2. The associated socket component 122 of the second embodiment is depicted in FIG. 6. FIG. 7 shows a further schematic longitudinal section view of the second embodiment of the tank shell 112 in accordance with the schematic longitudinal section view of FIG. 4.

The second embodiment of FIGS. 5 to 7 shall be elucidated hereunder only in so far as it differs from the first embodiment of FIGS. 1 to 4, to whose elucidation otherwise reference is made also for elucidating the second embodiment. Identical and functionally identical components and component sections as in the first embodiment are labelled in the second embodiment of FIGS. 5 to 7 with identical reference labels, but increased numerically by 100.

In contrast to the first embodiment, the inner wall section 126 of the ramp 128 of the second embodiment is configured as continuous in the circumferential direction around the aperture axis OA, as a continuous inner wall ring. Preferably the inner wall section exhibits along the entire circumference a constant axial dimension. As can be discerned first and foremost in the context of FIG. 7, the barrier foil 130 of the second embodiment extends not only over the bottom section 124b of the ramp 124 but also along the inner wall section 126 up to the latter's axial end. The inner wall section 126 forms, therefore, an axial collar 150 bordering the aperture 118, which by means of the barrier foil 130 prevents over its entire length migration of hydrocarbons through the inner wall section 126.

FIG. 6 shows the socket component 122 of the second embodiment in isolation. The socket component 122 is configured for combined firm bonding and positive connection with the tank shell 112. To this end, the stepped section 140 is configured as significantly axially longer than in the first embodiment.

In order to stabilize the shape of the socket component 122, at the longitudinal end of the stepped section 140 situated axially remotely from the gripping formations 136 there is configured an encircling radial projection 152 formed radially inwards.

Furthermore there are configured in the stepped section 140 breaches 154, which in the operational state are penetrated by injection-molding material. A plurality of breaches 154 are configured in the circumferential direction, preferably equidistant, encircling the aperture axis OA.

The stepped section 140 with the breaches 154 and the encircling radial projection 152 form an anchor section 155 and thus a lifting-off safeguard against lifting of the socket component 122 off the tank shell 112 in the lifting direction A.

As the longitudinal section view of FIG. 7 shows, because of the barrier foil 130 reaching up to the axial end of the inner wall section 126, the second embodiment no longer requires a separate sealing component.

The socket component 122 with its radial projection 152 is placed on the outwardly facing surface 130a of the barrier foil 130 in the region of the bottom section 124b. The groove formation 128, which when viewed axially from outside in the radial direction is concavely curved, is filled with outer injection-molding material 13, whereby the breaches 154 and the radial projection 152 are secured positively against lifting in the lifting direction A and whereby surface sections of the socket component 122, which are wetted solely by the outer injection-molding material 113, are firmly bonded with the tank shell 112.

As FIG. 7 further shows, the ramp 124 is formed in several steps, for example two steps, such that the ramp 124 of the second embodiment is radially wider than the ramp 24 of the first embodiment. Once again the radially outer rim 138 of the socket component 122 abuts on the external side 112b of the tank shell 112.

The axially end-side rim of the inner wall section 126 overtops axially the external side 112b of the tank shell 112, in particular the section located radially immediately outside the socket component 122. An excellent permeation barrier can thereby be achieved in the rim region 120 around the aperture 118.

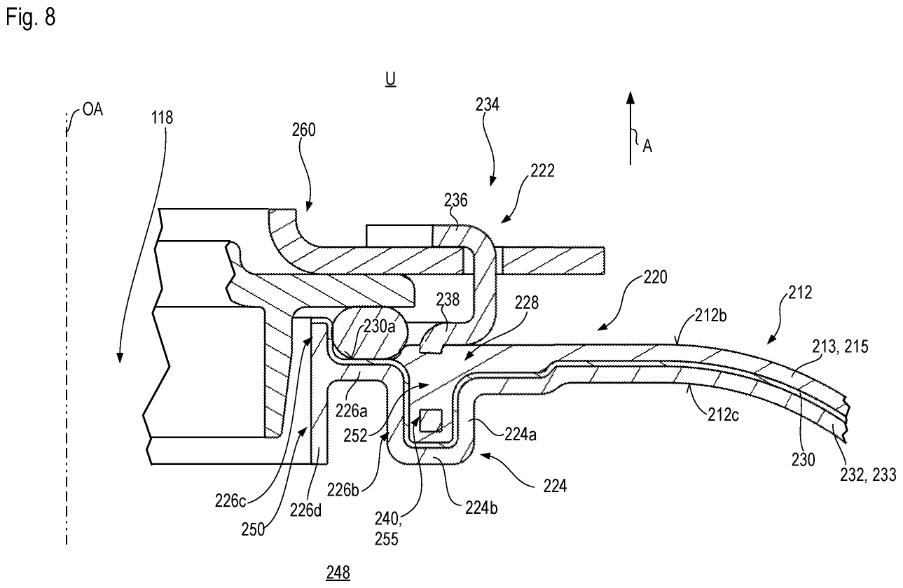

FIG. 8 depicts a third embodiment of the invention's tank shell in a schematic longitudinal section view along a sectional plane containing the aperture axis OA. The perspective of FIG. 8 therefore corresponds essentially to the perspective of FIGS. 4 and 7.

The third embodiment of FIG. 8 is similar to the second embodiment of FIGS. 5 to 7, since the socket component 222 of the third embodiment also is firmly bonded and connected positively with the tank shell 212.

The third embodiment shall be described hereunder only in so far as it differs from the preceding embodiments, to whose description reference is made expressly also for elucidating the third embodiment. Identical and functionally identical components and component sections as in the first two embodiments are labelled with identical reference labels, but in the numerical range from 200 to 299.

The socket component 222 of the third embodiment exhibits breaches 252 also, which are penetrated through by outer injection-molding material 213. The socket component 222, however, does not exhibit a radial projection at the axial end situated remotely from the gripping formations 236, i.e. the anchor section 255 is formed solely by the stepped section 240 with its breaches 252. Consequently, the anchor section is radially short and can be inserted in a likewise radially short groove formation 228.

The inner wall section 226 exhibits an encircling plateau section 226a, which proceeds transversely, especially preferably orthogonally, to the aperture axis OA. On the side of the plateau section 226a which is located axially nearer to the space region 248 on the internal side 212c of the tank shell 212 there extends an axially interior inner wall part-section 226b and on the side of the plateau section 226a which is located axially nearer to the external environment U of the tank shell 212 there extends an axially exterior inner wall part-section 226c. The plateau section 226a proceeds radially between the axially interior inner wall part-section 226b and the axially exterior inner wall part-section 226c. The inner wall part-sections 226b and 226c are arranged radially offset relative to one another.

In the third embodiment of FIG. 8 there is arranged at the socket component 222 a functional component 260, for example an extracting module for extracting fuel from the tank volume. The functional component in FIG. 8 is multi-part.

In order to seal the rim region 220 against the functional component 260 also, there is arranged a sealing component 262, once again for example an O-ring, between the rim region 220 and the functional component 260. In the embodiment example of FIG. 8, the sealing component 262 is arranged in a region which axially towards the tank volume and/or towards the space region 248 respectively is bounded by the plateau section 226a, which radially inwards is bounded by the axially exterior inner wall part-section 226c, which radially outwards is bounded by the outer injection-molding material 213 and/or the outer tank wall structure 215 respectively, and which axially towards the external environment is bounded by a section of the functional component 260. The aforementioned radial boundaries can be dispensed with on one side or on both radial sides. It is, however, important that the sealing component 262 is arranged between the functional component 260 and the tank shell 212 with sufficient contact pressure onto the aforementioned components. Once again, in order to achieve the best possible permeation protection the sealing component 262 abuts on an exposed surface 230a of the barrier foil 230 which forms a sealing region as aforementioned.

Despite the stepped configuration of the inner wall section 226, the rim region 220 of the tank shell 212 exhibits an axially long collar 250 bordering the aperture 218, since on the internal side of the tank shell 212 there is injected by injection molding a collar section 226d which extends the axially exterior inner wall part-section 226c axially inwards.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-15. (canceled)

16. A tank shell as a component of a motorized vehicle tank, where the tank shell comprises as wall components a barrier foil and injection-molding material injected thereon at least locally on at least one side, where the tank shell; exhibits an aperture configured for the arrangement of a functional component configured with a space section located on an internal side of the tank shell, wherein in a rim region of the tank shell surrounding the aperture there is arranged a socket component, which at least section-wise is formed from a material differing from the materials of the wall components of the tank shell, where the socket component is connected positively and/or is firmly bonded with the rim region of the tank shell.

17. The tank shell according to claim 16, wherein the rim region of the tank shell exhibits a ramp encircling the aperture, which relative to a virtual aperture axis conceived as penetrating the aperture centrally proceeds both along the aperture axis and transversely to the aperture axis, where a section of the socket component overlaps the ramp radially when viewed axially along the aperture axis.

18. The tank shell according to claim 17, wherein the ramp is configured as a stepped ramp with a predominantly axially proceeding wall section and a predominantly radially proceeding bottom section.

19. The tank shell according to claim 17, wherein in a region of the ramp a sealing component is accommodated between the tank shell and the socket component.

20. The tank shell according to claim 19, wherein the sealing component abuts on at least one of the barrier foil and/the socket component.

21. The tank shell according to claim 17, wherein in a region of the ramp there is injected injection-molding material which connects the socket component with the tank shell.

22. The tank shell according to claim 17, wherein the ramp is part of a concave groove formation of the tank shell encircling the aperture.

23. The tank shell according to claim 22, wherein the concave groove formation exhibits a radially interior inner wall section which proceeds predominantly in the axial direction, where the ramp is situated radially outside the inner wall section.

24. The tank shell according to claim 23, wherein the inner wall section overtops the ramp axially towards the tank's external side.

25. The tank shell according to claim 23, wherein the inner wall section is free in whole or in part from the barrier foil.

26. The tank shell according to claim 23, wherein the inner wall section is configured as discontinuous in the circumferential direction about the aperture axis, where in discontinuities of the inner wall section there are arranged wall projections of the socket component.

27. The tank shell according to claim 16, wherein the socket component is connected with the rim region of the tank shell by means of crimping and/or riveting.

28. The tank shell according to the claim 26, wherein the socket component is connected with the rim region of the tank shell by means of crimping and/or riveting, and wherein the connection of the socket component with the rim region of the tank shell is formed by means of plastic deformation of wall projections of the socket component so as to produce a positive fit engagement that engages behind the tank shell.

29. A motorized vehicle tank with at least one tank shell according to claim 16.

30. A motorized vehicle with a motorized vehicle tank according to claim 29.
